(19) United States
(12) Patent Application Publication
(10) Pub. No.: US 2006/0013973 A1
(43) Pub. Date: Jan. 19, 2006

(54) Composition for tank with single-layer wall

(76) Inventors: Bruno Flaconneche, Cormeilles en vexin (FR); Jacques Jarrin, Manterre (FR); Emmanuel Vinciguerra, Nanterre (FR); Marie-Helene Klopffer, Paris (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/517,630

(22) PCT Filed: Jun. 3, 2003
(86) PCT No.: PCT/FR03/01671

§ 371 Date: Aug. 12, 2005

(30) Foreign Application Priority Data
Jun. 13, 2002 (FR) 02/07246

(51) Int. Cl. B29D 22/00

(52) U.S. Cl. 428/35.7

(57) ABSTRACT

The present invention relates to a composition comprising a mixture of polymer material (4) and of mineral fillers (5) allowing to obtain a sealing barrier to hydrocarbons. The mixture comprises a predetermined proportion of specific mineral fillers for adsorption of all or part of the hydrocarbons that pass through the material by permeability. The proportion is determined depending on the permeability of the polymer material. The invention also relates to its applications to hydrocarbon tanks (gasoline, diesel oil, solvents) for example for motor vehicles, or hydrocarbon-carrying lines.

### FIELD OF THE INVENTION

The present invention relates to a composition comprising a mixture of polymer material and of one or more mineral fillers specifically selected to improve sealing of the polymer material against hydrocarbons by trapping within the polymer material the hydrocarbons that pass through the polymer by permeability.

The invention notably applies to all the hydrocarbon storage or transportation structures, in particular the gasoline and diesel oil tanks, lines, in motor vehicles.

### BACKGROUND OF THE INVENTION

Hydrocarbon storage and transportation poses problems linked with the permeability of the thermoplastic polymers used to manufacture the storage and transportation structures. In the particular case of the gasoline tanks of motor vehicles, the amount of hydrocarbon fumes released into the environment because of the permeability of the tank walls is subject to already strict standards that are going to be increasingly severe. The harshest current standards are the American standards (CARB and EPA) which recommend an 0.5 g/25 h emission per vehicle, knowing that each manufacturer then attributes 25% to 35% of these 0.5 g to the permeability of the fuel tank, i.e. 100 to 200 mg/25 h. Furthermore, the new ZEV standard (Zero Emission Vehicle) will bring the hydrocarbon emission level of the vehicle down to 0.35 g/25 h with a nearly zero contribution (i.e. about 45 to 55 mg/25 h) of the fuel system, and notably with an extremely low emission level guarantee throughout the life of the vehicle.

The following documents describe polymer tanks:
U.S. Pat. No. 5,928,745 which describes a two-layer polymer gasoline tank whose second layer contains a disperse cyclodextrine and/or substituent phase,
EP-1,108,598 and EP-1,108,599 which describe multilayer tanks at least one layer of which consists of a nanocomposite material.

### SUMMARY OF THE INVENTION

The present invention thus relates to a composition having controlled hydrocarbon permeability, comprising a mixture of polymer material and of fillers. The fillers are mineral and selected to adsorb and trap an amount of hydrocarbons discharged through the polymer so as to reduce the permeability of the composition.

The adsorbent mineral fillers can be selected from the following group : zeolite, activated charcoal, carbon nanotubes and mixtures thereof.

The polymer can be selected from among: polyolefins (PE, PP), polyamides, fluoropolymers, polymer alloys (PE-PA), elastomers.

The polymer material can comprise permeability-reducing fillers of micrometric type such as talc, metal particles, for example, or of nanometric type such as clays.

The invention relates to a structure whose wall is a single layer of the composition defined above.

At least one face of the wall can be treated, for example by fluorination, to reduce the permeability.

The structure can be made by extrusion, injection, blowing, rotational moulding or compression.

The invention can be applied to the manufacture of tanks for motor vehicles.

The invention can be applied to the manufacture of fuel lines for motor vehicles.

The present invention relates to a single-layer material of reduced permeability by means of a function of adsorption trapping, on specific fillers, of all or part of the hydrocarbons discharged through this single layer.

The present invention is mainly based on adsorption trapping of the hydrocarbons by mineral fillers, for example zeolites, activated charcoal, carbon nanotubes. These fillers, known for their adsorption capacity, are already used in the pure state in reserves, but not in combination with a polymer matrix so as to obtain the advantages of the present invention. According to the invention, the amount of filler to be added to the polymer is calculated from knowledge of the permeability of the polymer alone and of the amount of hydrocarbons potentially released during the life of the vehicle through the polymer.

The polymer materials used have to be compatible with the implementation methods used for manufacture of the type of structures considered (hydrocarbon storage tanks, or lines) and can therefore be polyolefins (polyethylene, polypropylene), polyamides (11, 12, 6, 6-6, 6-10, . . . ), fluoropolymers (PVDF, . . . ), thermoplastic polymers, elastomers, or thermosetting resins.

In order to improve the composition performance, and thus to decrease the amount of adsorbent filler to be added, micrometric or nanometric particle fillers can be used so as to reduce the permeability of the polymer, or the single layer according to the invention can be subjected to a surface treatment (fluorination of the polyolefins for example).

### BRIEF DESCRIPTION OF THE FIGURES

Other features and advantages of the invention will be clear from reading the description hereafter, given by way of non limitative example, with reference to the accompanying figures wherein:

FIG. 1 illustrates one of the structures of the prior art,

FIG. 2 diagrammatically shows the principle of the invention, and

FIGS. 3a, 3b, 3c illustrate variants of the present invention.

### DETAILED DESCRIPTION

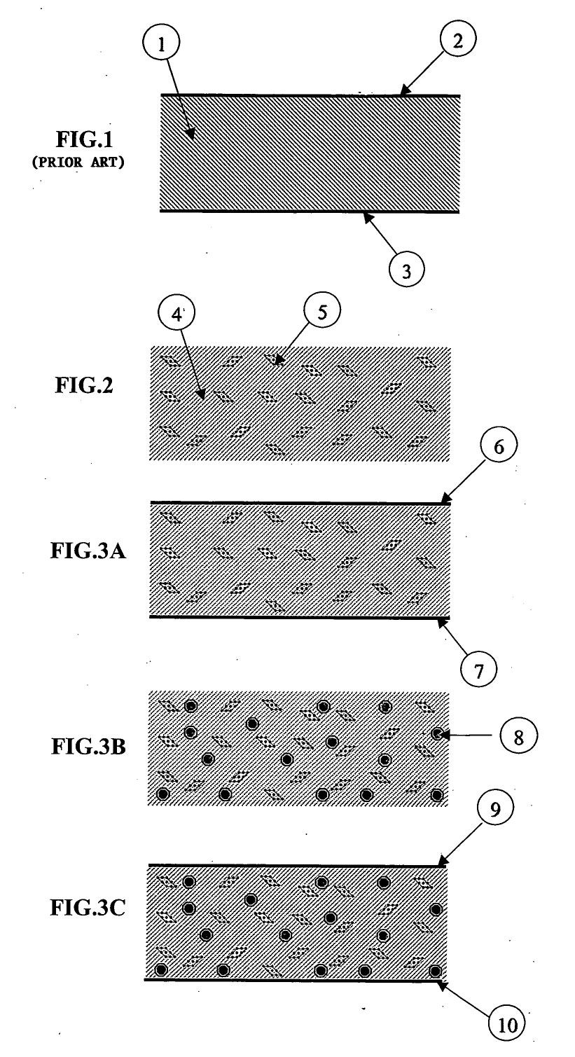

According to FIG. 1, the most commonly used material is a layer 1 of two-faced (2 and 3) fluorinated polyolefin intended to reduce the permeability of polymer 1. These surface treatments are relatively costly and do not allow the permeability problems to be completely solved.

FIG. 2 shows the principle of the composition according to the invention comprising a polymer matrix wherein mineral fillers are dispersed. The function of the mineral fillers selected is to adsorb the hydrocarbon molecules that can pass through the polymer matrix. The filler has no significant effect on the permeability value of the matrix, but it acts as a trap for the hydrocarbon molecules, thus preventing them from passing completely through the wall and from dispersing in the atmosphere.

In FIG. 3a, a surface treatment 6, 7 has been applied, by fluorination for example.

FIG. 3b is a variant of the invention wherein the single layer consists of a composition similar to that of FIG. 2, but where the permeability of the matrix is reduced by addition of micrometric or nanometric particles.

FIG. 3c is a variant of the invention according to the variant of FIG. 3b wherein the faces of the layer are treated 9, 10. The latter variant is the most effective as regards the permeability of motor vehicle tanks.

The polymer gasoline tank of a motor vehicle is manufactured in most cases by extrusion-blowing, and the amount of material used is about 6 kg in the case of polyethylene.

The hydrocarbon emissions measured by means of the SHED test on this type of structure according to the current standards can be estimated between 150 and 400 mg/25 hours.

Fuel absorption measurements performed on polyethylene+adsorbent filler mixtures according to the invention have allowed to obtain collection rates of the order of 15% to 25% for the filler, which corresponds to an adsorption of 150 mg to 250 mg/g filler.

Addition of micrometric or nanometric fillers allows the permeability to be reduced by a factor 2 to 5.

Considering average values for hydrocarbon emissions from a tank (i.e. about 250 mg/25 h), the emission of this structure is calculated for 10 years: about 850 g in 10 years.

By taking account of the addition of permeability-reducing fillers (micrometric or nanometric fillers), we can consider that, for 10 years, the hydrocarbon emissions will range between 170 g and 425 g.

Considering a collection rate of 20% for adsorbent fillers, 800 g to 2 kg adsorbent fillers have to be added to trap all of the fumes released during the 10-year life of the vehicle, which corresponds to a mass proportion of fillers of the order of 10 to 35% for a tank.

This calculation is not optimized and, if one of these data changes (polymer type, emissions decrease, collection improvement, . . . ), the proportions of adsorbent fillers can be greatly reduced.

It is therefore clear that these mass proportions pose no industrial problem for the manufacture of polymer tanks. Thus, the invention and its variants afford a definite advantage for the reduction of hydrocarbon emissions from a hydrocarbon-containing structure.

1. A controlled hydrocarbon permeability composition comprising a mixture of polymer material (4) and of fillers, characterized in that fillers (5) are mineral and selected to adsorb and to trap an amount of hydrocarbons discharged through said polymer so as to reduce the permeability of said composition.

2. A composition as claimed in claim 1, wherein said adsorbent mineral fillers are selected from the following group: zeolite, activated charcoal, carbon nanotubes and mixtures thereof.

3. A composition as claimed in claim 1, wherein the polymer is selected from : polyolefins (PE, PP), polyamides, fluoropolymers, polymer alloys (PE-PA), elastomers.

4. A composition as claimed in claim 1, wherein the polymer material comprises permeability-reducing fillers (8) of micrometric type, such as talc, metal particles for example, or of a nanometric type, such as clays for example.

5. A structure containing hydrocarbons, characterized in that its wall is a single layer of the composition as claimed in claim 1.

6. A structure as claimed in claim 5, wherein at least one face of said wall is treated (6), for example by fluorination, to reduce the permeability.

7. A structure as claimed in claim 5, made by extrusion, injection, blowing, rotational moulding or compression.

8. Application of the structure as claimed in claim 5 to the manufacture of tanks for motor vehicles.

9. Application of the structure as claimed in claim 5 to the manufacture of fuel lines for motor vehicles.

10. A composition as claimed in claim 2, wherein the polymer is selected from: polyolefins (PE, PP), polyamides, fluoropolymers, polymer alloys (PE-PA), elastomers.

11. A composition as claimed claim 2, wherein the polymer material comprises permeability-reducing fillers (8) of micrometric type, such as talc, metal particles for example, or of a nanometric type, such as clays for example.

12. A composition as claimed in claim 3, wherein the polymer material comprises permeability-reducing fillers (8) of micrometric type, such as talc, metal particles for example, or of a nanometric type, such as clays for example.

13. A structure containing hydrocarbons, characterized in that its wall is a single layer of the composition as claimed in claim 2.

14. A structure containing hydrocarbons, characterized in that its wall is a single layer of the composition as claimed in claim 3.

15. A structure containing hydrocarbons, characterized in that its wall is a single layer of the composition as claimed in claim 4.

16. A structure as claimed in claim 6, made by extrusion, injection, blowing, rotational moulding or compression.

17. Application of the structure as claimed in claim 6 to the manufacture of tanks for motor vehicles.

18. Application of the structure as claimed in claim 7 to the manufacture of tanks for motor vehicles.

19. Application of the structure as claimed in claim 6 to the manufacture of fuel lines for motor vehicles.

20. Application of the structure as claimed in claim 7 to the manufacture of fuel lines for motor vehicles.
